(19) United States
(12) Patent Application Publication
(10) Pub. No.: US 2011/0142653 A1
(43) Pub. Date: Jun. 16, 2011

(54) TWO PIECE IMPELLER

(75) Inventors: Behzad Hagshenas, San Diego, CA (US); Victor Pascu, San Diego, CA (US)

(73) Assignee: HAMILTON SUNDSTRAND CORPORATION, Windsor Locks, CT (US)

(21) Appl. No.: 12/636,036

(22) Filed: Dec. 11, 2009

(51) Int. Cl. F03B 3/12; B21K 25/00

(52) U.S. Cl. 416/186 R; 29/889.4

(57) ABSTRACT

A compressor impeller includes a hub and a plurality of blades. The hub is formed of first forged portion and a second forged portion that are bonded together. The first forged portion is comprised of a first alloy and the second forged portion is comprised of a second alloy that has lower fracture toughness than the first alloy. The blades are integral with and extend from the hub and are formed from the first forged portion. The hub is formed from both the first forged portion and the second forged portion.

### BACKGROUND

The present invention relates to gas turbine engines, and more particularly, to compressor impellers for compressor sections of turbine engines.

In gas turbine engines, the compressor section can include both a high pressure compressor and a low pressure compressor section of the engine. The compressor section raises the pressure of the air it receives from ambient or the fan section to a relatively high level. After compression in the compressor section, compressed air then enters the combustor section, where fuel is injected into the air and the gas/fuel mixture is ignited. The air then flows into and through the turbine section causing turbine blades therein to rotate and generate energy.

As the desire for greater power output and smaller packaging continues to increase, gas turbine engines have been configured to operate at higher temperatures and at higher pressures. For example, compressor sections are increasingly being designed to operate at high pressure ratios and high operating speeds. However, these pressure ratios tend to cause the air flowing through the compressor section to exit at extremely high temperatures (e.g., above 700° F.). Consequently, the materials and casting methods conventionally used to manufacture some of the compressor components may not be suitable for use in such environments.

Accordingly, it is desirable to have improved compressor components, such as forged impellers, that are adapted to operate under extreme conditions. However, the titanium alloys typically used to form components in high temperature and high stress applications generally have poor fracture toughness properties. Poor fracture toughness is not ideal in instances where the impeller comes into contact with foreign objects. The resulting damage can propagate cracks through the impeller. Also airborne gas turbine engines used as auxiliary power units have to demonstrate worst case scenario failure containment capabilities usually referred to as tri-hub containment. Containing a tri-hub failure with impellers made with low fracture toughness is very difficult due to sub-fragmentation of the impeller. The smaller fragments that typically result from such failures can be difficult to contain within the compressor shroud and containment bands.

### SUMMARY

A compressor impeller includes a hub and a plurality of blades. The hub is formed of first forged portion and a second forged portion that are bonded together. The first forged portion is comprised of a first alloy and the second forged portion is comprised of a second alloy that has lower fracture toughness than the first alloy. The blades are integral with and extend from the hub and are formed from the first forged portion. The hub is formed from both the first forged portion and the second forged portion.

### BRIEF DESCRIPTION OF THE DRAWINGS

FIG. 1A is a schematic cross-sectional view of an initial compressor impeller workpiece that has undergone forging and bonding processes.

FIG. 1B is a schematic cross-sectional view of the compressor impeller of FIG. 1A as it is reduced to a final shape by a machining process superimposed on the initial compressor impeller workpiece.

FIGS. 2A and 2B are schematic cross-sectional views of a top half portion of the final compressor impeller with superimposed operational temperature and stress gradients.

### DETAILED DESCRIPTION

This application relates to a two piece forged compressor impeller which has two pieces or portions that are bonded together to achieve desirable performance characteristics. The first portion of the compressor impeller is comprised of a first alloy that has high fracture toughness and is disposed in parts of the compressor impeller where high fracture toughness is desirable. In this manner, the severity of damage to the compressor impeller resulting from foreign objects can be reduced. This arrangement also minimizes any sub-fragmentation that results from a tri-hub failure event and maximizes the ability to contain the fragments within a compressor shroud or other containment bands. The second portion of the compressor impeller is comprised of a second alloy that performs well under conditions of high temperature and high stress. The second portion is disposed in parts of the compressor impeller associated with these conditions, thereby maintaining the durability of the compressor impeller while impeller failure due to fracture of the impeller from foreign objects is reduced and a failure to contain the fragments in the event of a tri-hub failure is reduced..

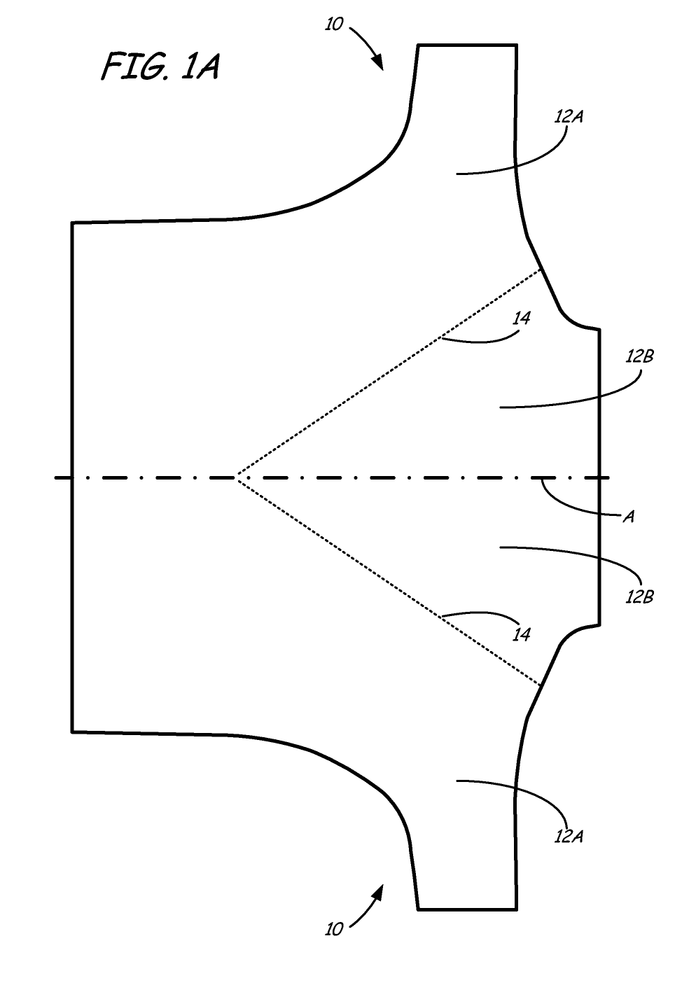

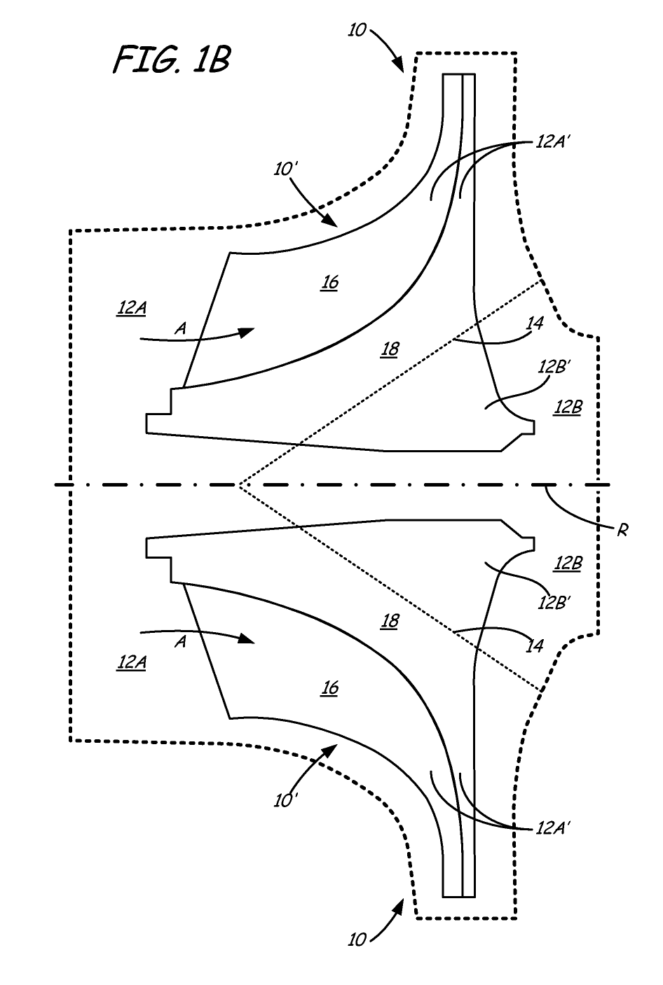

FIG. 1A shows a schematic cross-sectional view of an initial compressor impeller workpiece 10 that has been formed by forging and bonding processes. The initial compressor impeller workpiece 10 is symmetrical in shape and extends radially around an axis of symmetry A. Prior to forging and bonding, a first portion 12A and a second portion 12B can be pre-machined using conventional techniques (e.g., turning, grinding or milling) to remove localized discontinuities and to prepare the two portion for the subsequent joining process. The first portion 12A and the second portion 12B are forged using conventional techniques for titanium stock. For example, U.S. Pat. No. 3,635,068 to Watmough et al., which is incorporated herein by reference, discloses an “iso-thermal” process for forging titanium and titanium alloys, in which forging stock and a die structure are heated separately to a forging temperature, following which the stock is placed in the die, with contained heating if desired, and forging force is applied to the die to deform the stock to a predetermined shape. Similarly, U.S. Pat. No. 4,055,975 to Serfozo, which is incorporated herein by reference, teaches a process of precision forging of a titanium alloy in which the forging stock and a segmented die are first heated to forging temperature while separated, and are then assembled together and heated again to that temperature, with the stock being covered by a protective coating preferably containing glass grit, and the die sections being coated with lubricant. The heated die and contained heated forging stock are then inserted in a heated holder and the stock subjected to forging force, to partially but not completely deform the stock to the shape of the die cavity. The die and stock are then separated and the stock allowed to cool, any flashing is removed from the stock, the die is cleaned, the die and stock ware recoated and then reheated separately and then together, and the stock is forged again to assume more closely the shape of the die cavity. Further examples of patents teaching forging, the disclosures of which being incorporated herein by reference, include U.S. Pat. No. 5,493,888, U.S. Pat. No. 4,269,053, and U.S. Pat. No. 4,281,528.

As illustrated in FIG. 1A, the first portion 12A is bonded to the second portion 12B along a bond line 14. Bonding techniques are conventional and include electron-beam welding, inertia welding, diffusion welding, and brazing.

FIG. 1B shows a schematic cross-sectional view of the initial compressor impeller workpiece 10 (outlined in a dashed line) as it is reduced to a final shape by a machining process. Finished compressor impeller 10′ which is shown superimposed on the initial compressor impeller workpiece 10, includes a first portion 12A′ and a second portion 12B′. Blades 16 and a hub 18 are machined from the initial compressor impeller workpiece 10. The geometry of the blades 16 can vary as operational criteria within the gas turbine engine dictates. Machining processes can include grinding or milling such as the three-dimensional machining process disclosed in U.S. Pat. No. 5,587,912 to Andersson et al., which is incorporated herein by reference.

The blades 16 the final compressor impeller 10′extend from the hub 18 generally radially away from a rotational axis R (which coincides with the axis of symmetry A from FIG. 1A) of the impeller 10′. The first portion 12A′ is configured to mate with the second portion 12B′. In the embodiment shown in FIG. 1B, the first portion 12A′ comprises the blades 16 and a forward (as defined by the direction of flow of air A) portion of the hub 18. The first portion 12A′ is forged from a first alloy. In one embodiment, the first alloy is titanium 6-4 (Ti 6-4) alpha-beta alloy such as TIMETAL® 6-4 retailed by Timet of Denver, Colo.. Titanium 6-4 is a general-purpose alpha-beta alloy in widespread use and is composed of between 5.5 and 6.5 percent (by weight) aluminum, between 3.5 and 4.5 percent (by weight) vanadium, with the remainder (excluding some residual elements) titanium. In another embodiment, the first alloy is a titanium 6-2-4-6 beta alloy. Typically, the first alloy should have material properties that include a fracture toughness that is above 50 ksi/(in)̂0.5 (57.1 MPa/(m)̂0.5) at room temperature, which allows the first portion 12A′ to be relatively more ductile than the second portion 12B′.

In FIG. 1B, the second portion 12B′ comprises a second part of hub 18. The second portion 40B is forged from a second alloy that differs from that of the first alloy. In one embodiment, the second alloy is titanium 6-2-4-6 (Ti 6-2-4-6) such as TIMETAL® 6-2-4-6 retailed by Timet of Denver, Colo.. Titanium 6-2-4-6 is an alpha-beta alloy capable of being heat treated to higher strengths in greater section sizes than the titanium 6-4 alloy. Titanium 6-2-4-6 is composed of between 5.5 and 6.5 percent (by weight) aluminum, between 1.75 and 2.25 percent (by weight) tin, between 3.6 and 4.4 percent (by weight) zirconium, between 5.5 and 6.5 percent (by weight) molybedenum, with the remainder (excluding some residual elements) titanium. The second alloy typically has material properties that allow it to absorb higher stress and higher temperatures during operation of the gas turbine engine than the first alloy. The second alloy also typically will have better fatigue strength capability than that of the first alloy. However, in general, the second alloy will have a fracture toughness that is lower than the fracture toughness of the first alloy.

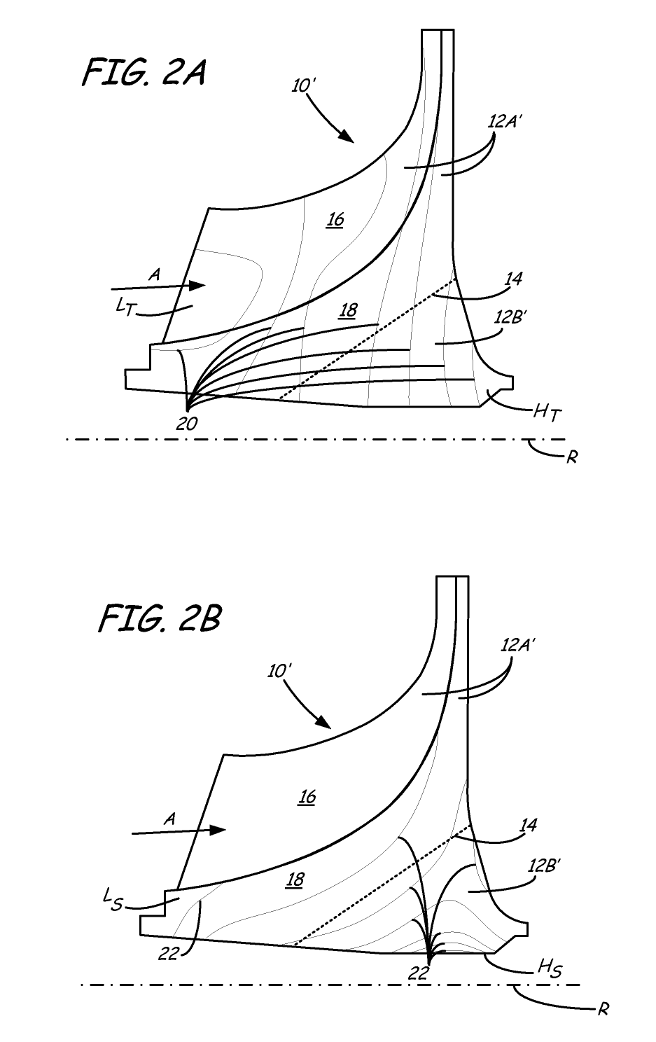

FIGS. 2A and 2B show the cross-sectional views of a top half portion of the finished compressor impeller 10′ with temperature profile lines 20 and stress profile lines 22 superimposed thereon. The temperature profile lines 20 and stress profile lines 22 illustrate operational temperature and stress gradients within the compressor impeller 10′. As shown in FIGS. 2A and 2B, the first portion 12A′ includes an outer section of the hub 18 and comprises the blades 16. The second portion 12B′ includes a second part of the hub 18 that is disposed generally radially inward (with respect to the axis of rotation R of the finished compressor impeller 10′) and axially aft (as defined by the direction of flow of air A) of the first portion 12A′. Temperature profile lines 20 are superimposed along compressor impeller 10′ and illustrate parts of the cross-section that typically have the same temperature during one mode of operation. As shown in FIG. 2A, the second portion 12B′ is disposed in higher temperature gradient regions including a highest temperature gradient region H_{T} of the compressor impeller 10′. FIG. 2A shows that the regions generally axially at a forward section of the compressor impeller 10′ (as defined by the direction of flow of air A) are subject to lower operational temperatures and experience decreased intensity of temperature gradients. The first portion 12A′ is disposed in lower temperature gradient regions including a lowest temperature gradient region L_{T} of the compressor impeller 10′.

Similarly, FIG. 2B shows that the second portion 12B′ is disposed in higher stress gradient regions including a highest stress gradient region H_{S} of the compressor impeller 10′. Stress profile lines 22 are superimposed along compressor impeller 10′ and illustrate parts of the cross-section that typically have the same level of stress during one mode of operation. FIG. 2B shows that regions generally axially at a forward section of the compressor impeller 10′ (as defined by the direction of flow of air A) or generally radially outward from the axis of rotation R are subject to lower operational stresses and experience decreased intensity of stress gradients. The first portion 12A′ is disposed in lower stress gradient regions including a lowest stress gradient region L_{S} of the compressor impeller 10′.

The size, shape, and disposition (relative to one another) of the first portion 12A′ and the second portion 12B′ can be optimized for operational performance. For example, by selecting an alloy for the first portion 12A′ which performs well (has desirable material properties) under conditions of higher temperature and stress, the size of the first portion 12A′ can be increased (i.e. extend further aft) relative to that of the second portion 12B′ over the size illustrated in the FIGURES. However, it should be recognized that by selecting an alloy that performs better under conditions of high temperature and stress, there maybe some trade-offs with regard to the fracture toughness of the first portion 12A′ which may not be desirable. Similarly, the material properties of the second alloy forming the second portion 12B′ can be varied in a manner similar to those disclosed above so as to vary the size, shape and disposition of the second portion 12B′ relative to the first portion 12A′. Additionally, expected cycles of operation of the gas turbine engine, and expected stress levels on the compressor impeller 10′ during operation of gas turbine engine can influence the size, shape, and disposition (relative to one another) of the first portion 12A′ and the second portion 12B′.

The expected operational performance of the compressor impeller 10′ as influenced by the alloy selected to comprise the first portion 12A′, the alloy selected to comprise the second portion 12B′, the expected cycles of operation of the gas turbine engine, and the expected stress levels on the compressor impeller 10′ during operation can be modeled and optimized using commercially available finite element analysis and computational fluid dynamics software such as software retailed by ANSYS, Inc. of Canonsburg, Pa.. Additionally, the size, shape and disposition of the first portion 12A′ and the second portion 12B′ can be determined based upon ease of manufacture and installation. Considering the above factors, the bond line 14 between the first portion 12A′ and the second portion 12B′ can vary in shape from the straight bond line 14 depicted in the FIGURES, and can be curved or otherwise shaped to optimize performance of the compressor impeller 10′.

By disposing the second portion 12B′ in areas of the compressor associated with high operating temperature and high operating stress, the durability of compressor impeller 10′ can be maintained. By conventionally bonding the first portion 12A′ to the second portion 12B′, and disposing first portion 12A′ in areas of the compressor impeller 10′ where high fracture toughness is desirable, the tolerance to damage of compressor impeller 10′ resulting from foreign objects can be increased. Also this arrangement minimizes the sub-fragmentation that results from a tri-hub failure event and maximizes the ability to contain the fragments within the compressor shroud or other containment means.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A compressor impeller, comprising:
a hub formed of a first forged portion and a second forged portion that are bonded together, wherein the first forged portion is comprised of a first alloy and the second forged portion is comprised of a second alloy that has a lower fracture toughness than the first alloy; and
a plurality of blades integral with and extending from the hub, wherein the blades are formed from the first forged portion and the hub is formed from both the first forged portion and the second forged portion.

2. The impeller of claim 1, wherein the first alloy is titanium 6-4 alpha-beta alloy or titanium 6-2-4-6 beta alloy.

3. The impeller of claim 1, wherein the second alloy is titanium 6-2-4-6 alpha-beta alloy.

4. The impeller of claim 1, wherein the first forged portion is bonded to the second forged portion by at least one of: inertia welding, electron-beam welding, diffusion welding, and brazing.

5. The impeller of claim 1, wherein the first forged portion and the second forged portion have sizes and shapes that are selected based on at least one of: material properties of the first alloy, material properties of the second alloy, expected cycles of operation of the impeller, and expected stress levels during operation of the impeller.

6. The impeller of claim 1, wherein the first forged portion is radially outward of the second forged portion with respect to an axis of rotation of the compressor impeller.

7. The impeller of claim 6, wherein the second forged portion comprises a second hub section that is disposed generally axially aft of the first forged portion as defined by the direction of flow of a working fluid.

8. A method of manufacturing a compressor impeller having a first portion and a second portion, comprising:
forging the first portion from a first alloy;
forging the second portion from a second alloy, the second alloy having lower fracture toughness than the first alloy;
bonding the first portion and the second portion together to form a compressor impeller workpiece; and
machining the compressor impeller workpiece to create the compressor impeller having a hub and blades, wherein the blades are formed by the first portion and the hub is formed by both the first portion and the second portion.

9. The method of claim 8, further comprising selecting a size and shape of both the first portion and the second portion based on at least one of: material properties of the first alloy, material properties of the second alloy, expected cycles of operation of the impeller, and expected stress levels during operation of the impeller.

10. The method of claim 8, wherein the bonding is accomplished by at least one of: inertia welding, electron-beam welding, diffusion welding, or brazing.

11. The method of claim 8, wherein the first alloy is titanium 6-4 alpha-beta alloy or titanium 6-2-4-6 beta alloy.

12. The method of claim 8, wherein the second alloy is titanium 6-2-4-6 alpha-beta alloy.

13. The method of claim 8, further comprising machining the first portion and the second portion prior to bonding.

14. The method of claim 8, wherein the first forged portion is radially outward of the second forged portion with respect to an axis of rotation of the compressor impeller.

15. The method of claim 14, wherein the second forged portion comprises a second hub section that is disposed generally axially aft of the first forged portion as defined by the direction of flow of a working fluid.
